(19) United States
(12) Patent Application Publication
(10) Pub. No.: US 2025/0353325 A1
(43) Pub. Date: Nov. 20, 2025

(54) Vehicle Wheel and Vehicle Including the Same

(71) Applicants: Hyundai Motor Company, Seoul (KR); Kia Corporation, Seoul (KR)

(72) Inventors: Eun Sik Kim, Hwaseong-Si (KR); Ju Ho Kim, Hwaseong-Si (KR)

(21) Appl. No.: 18/904,207

(22) Filed: Oct. 2, 2024

(30) Foreign Application Priority Data
May 14, 2024 (KR) 10-2024-0062957

(51) Int. Cl. B60B 15/06; B60B 3/10

(52) U.S. Cl. CPC B60B 15/06; B60B 3/10

(57) ABSTRACT

A vehicle wheel may include: a wheel disk including a hub, a plurality of spokes extending from the hub in a radial direction, and a wheel rim provided outside of the spokes; a hook-shaped anti-slip member provided on the wheel disk and capable of protruding to the outside of the wheel rim by rotation; and a driving unit driving the anti-slip member.

### CROSS-REFERENCE TO RELATED APPLICATION(S)

This application claims benefit of priority to Korean Patent Application No. 10-2024-0062957 filed on May 14, 2024 in the Korean Intellectual Property Office, the disclosure of which is incorporated herein by reference in its entirety.

### TECHNICAL FIELD

The present disclosure relates to a vehicle wheel and a vehicle including the same.

### BACKGROUND

Vehicle wheels are installed on and connected to an axle, and tires in/for contact with the ground are installed on the wheels.

Vehicles should be able to be driven even in winter, but snows or ice on a road (e.g., due to sub-zero temperatures) may cause a problem such as an accident due to tire slippage.

Winter tires or snow chains can be used to help prevent tire slippage, but winter tires have the inconvenience of having to be changed separately, depending on the season, and winter snow chains not only have the inconvenience of having to be inserted thereinto separately in the case of an emergency, but also have the disadvantage of deteriorating vehicle driving performance.

### SUMMARY

The following summary presents a simplified summary of certain features. The summary is not an extensive overview and is not intended to identify key or critical elements.

Systems, apparatuses, and methods are described for a vehicle wheel. The vehicle wheel may comprise a wheel disk comprising: a hub, a plurality of spokes extending from the hub in an outward radial direction, and a wheel rim provided radially outside of the spokes; a hook-shaped anti-slip member connected to the wheel disk so as to be capable of reversibly rotating about an axis on the wheel rim so as to protrude radially outside of the wheel rim; and a driver configured to drive the anti-slip member to rotate about the axis.

Also, or additionally, a vehicle may comprise a body and a vehicle wheel as disclosed herein.

These and other features and advantages are described in greater detail below.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a combined perspective view of a vehicle wheel according to an example of the present disclosure.

FIG. 2 an exploded perspective view of a vehicle wheel according to an example of the present disclosure.

FIG. 3 is a reference diagram illustrating an example in which an anti-slip member of a vehicle wheel according to an example of the present disclosure is installed to rotate about an axis.

FIG. 4 illustrates an example of an anti-slip member installed on a vehicle wheel and a driving unit according to an example of the present disclosure.

FIG. 5A is a cross-sectional perspective view illustrating an example before an anti-slip member of a vehicle wheel according to an example of the present disclosure is installed to rotate about an axis.

FIG. 5B is a cross-sectional perspective view illustrating an example after an anti-slip member of a vehicle wheel according to an example of the present disclosure is installed to rotate about an axis on a tire.

FIG. 6 is a side view illustrating a state after an anti-slip member of a vehicle wheel according to an example of the present disclosure is installed to rotate about an axis on a tire.

FIG. 7 is another example of a driving unit installed on an anti-slip member installed on a vehicle wheel according to an example of the present disclosure.

FIG. 8 is a reference diagram illustrating a vehicle to which a vehicle wheel according to an example of the present disclosure is applied.

### DETAILED DESCRIPTION

Since the present disclosure may have various changes and may have various examples of the present disclosure, specific examples may be illustrated in the drawings and described in detail. However, this is not intended to limit the present disclosure to specific examples, it should be understood to include all modifications, equivalents, and substitutes included in the spirit and technical scope of the present disclosure.

Terms such as “first”, “second”, and the like may be used to describe various elements, but the elements should not be limited by the terms. The above terms may be used only for distinguishing one component from another. For example, without departing from the scope of the present disclosure, a first component may be referred to as a second component, and similarly, a second component may also be referred to as a first component. The term “and/or” may include a combination of a plurality of related listed items or any of the plurality of related listed items.

Terms such as “unit”, “part”, “portion”, and the like may be used to describe various components, but the components should not be limited by the above-described terms. The above-described terms may be terms not only referring to describing a physically/visually distinct component, but also terms referring to describing the function or component of the corresponding portion even if is not clearly divided or demarcated.

The terms used in the present application may be only used to describe specific examples, and are not intended to limit the present disclosure. The singular expression may include the plural expression, unless the context clearly dictates otherwise. In the present application, it should be understood that terms such as “include,” “comprise,” or “have” are intended to designate that features, numerals, steps, operations, components, parts, or combination thereof described in the specification exists, but one or more other features this does not preclude the existence or addition of numbers, steps, operations, components, parts, or combinations thereof.

Unless defined otherwise, all terms used herein, including technical or scientific terms, have the same meaning as that which can commonly understood by one of ordinary skill in the art to which the present disclosure belongs. Terms such as those defined in a commonly used dictionary should be interpreted as having meanings consistent with the meaning in the context of the related art, and should not be interpreted in an ideal or excessively formal manner unless explicitly defined in the present application.

In this specification, a vehicle refers to device vehicles for transporting an object (e.g., people, animals, or goods) from a starting point to a destination. A vehicle herein is not limited to vehicles configured for running on roads or tracks, but may also include off-road or flying vehicles, for instance. Vehicles herein may refer to vehicles configured to fun on any fuel or power source, including fossil fuels such as gasoline or the like, electricity (e.g., stored in batteries, or the like), an/or future fuels (e.g., hydrogen).

In the description below, the terms “frontward,” “backward,” “lateral,” “front,” “back,” “up/down,” “above,” “upper,” “upper portion,” “below,” “lower,” “lower portion,” “left and right,” and the like used in relation to direction are defined based on a vehicle or a vehicle body. Also, or alternatively, terms such as “first,” “second,” and the like may be used to describe various components, but these components are not limited in order, size, location, or importance by terms such as first second, and the like, and the terms such as first and second are named only for the purpose of distinguishing one component from another component.

Hereinafter, examples of the present disclosure will be described in more detail with reference to the accompanying drawings.

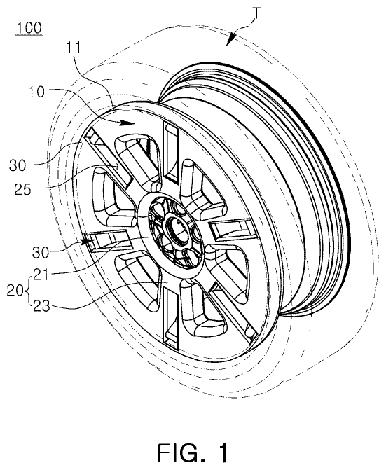

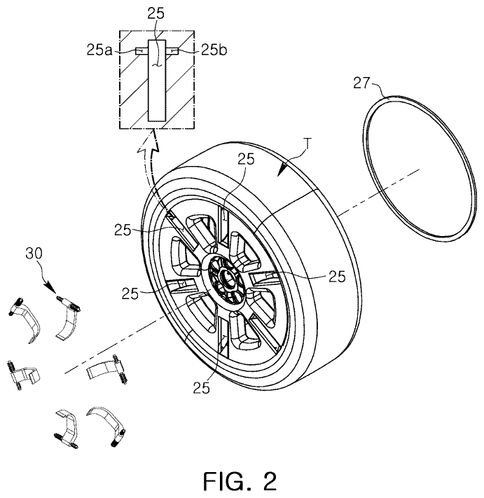

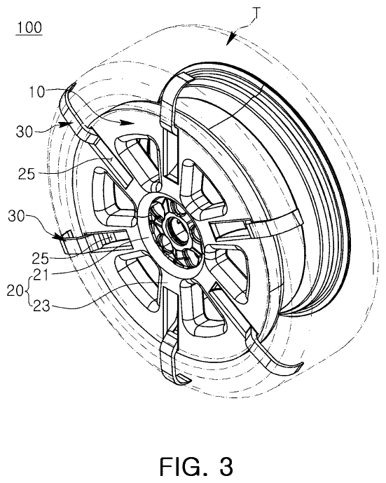

FIG. 1 is a combined perspective view of a vehicle wheel according to an example of the present disclosure, FIG. 2 an exploded perspective view of a vehicle wheel according to an example of the present disclosure, and FIG. 3 is a reference diagram illustrating an example in which an anti-slip member of the vehicle wheel is installed to rotate about an axis according to an example of the present disclosure.

Referring to FIGS. 1 to 3, a vehicle wheel 100 may be configured to connect to an axle of a vehicle and may be applied to, for example, a wheel/tire assembly of a passenger vehicle. The wheel 100 may include a wheel rim 10 and a wheel disk 20. The wheel disk 20 may be comprise the wheel rim 10.

A radial direction and/or a direction of a radius may be a direction away or towards an axis of rotation of the wheel (e.g., from a hub 21 to a rim flange 11), a circumferential direction may be a direction perpendicular to the radial direction and the axis of rotation (e.g., in which the vehicle wheel 100 is configured to rotate), and a thickness direction may be a direction of the axis of rotation (e.g., in which an axle would extend when coupled to the vehicle wheel 100).

The wheel rim 10 may be a portion of the wheel on which a tire T may be mounted. The wheel rim may have a rim flange 11 on both sides of the wheel 100 in a width direction. The wheel disk 20 may include a hub 21 couplable to an axle at an inner central side of the wheel rim 10, and/or a plurality of spokes 23 radially connected the hub 21 and the rim flange 11.

The wheel disk 20 may form open spaces of a set area between the spokes 23. The spokes 23 may be provided to have a constant width and/or gradually become smaller and/or larger from the rim flange 11 toward the hub 21. Accordingly, the open space may be provided to have a constant width or gradually become narrower from the rim flange 11 toward the hub 21. In the drawings of the present example, only the shape in which the width of the open space increases in the radial (radius) direction is shown for convenience of illustration, but the present disclosure is not limited thereto.

Since the basic configuration of the wheel rim 10 and the wheel disk 20 is a known technology widely known to those skilled in the art, a more detailed description of the configuration will be omitted in this specification.

The vehicle wheel 100 according to an example of the present disclosure may include a snow chain structure having a simple structure, and that can be easily and efficiently installed in the case of an emergency such as during snowfall or when roads are icy. In the case of an emergency, by simply operating the driving unit, the vehicle wheel 100 may cause snow chains provided on vehicle wheels to be installed to rotate about an axis, and cause the installation of snow chains to be easily released once a snowy or icy region is passed.

Accordingly, in the present disclosure, the inconvenience of installing snow chains in the winter or changing tires for the winter may be eliminated and/or reduced, and the driver's convenience in using the snow chains will be improved since the installation and release of the snow chains may be simply performed by button operation.

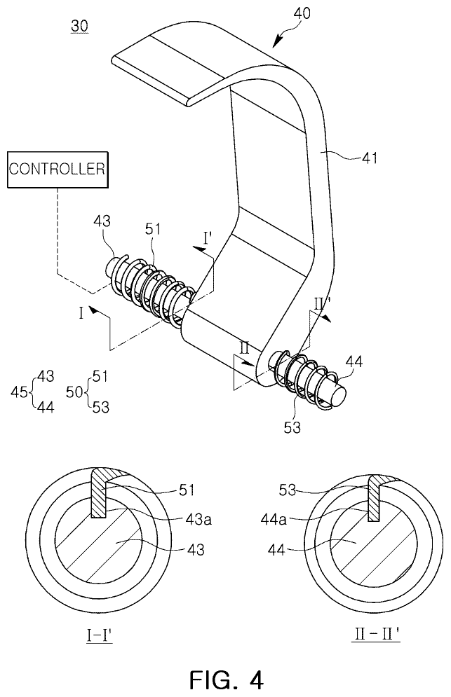

Referring to FIG. 4, the vehicle wheel 100 according to an example of the present disclosure may include an anti-slip member 40 and a driving unit 50 (e.g., a driver, a motor, etc.) driving the same to implement the snow chain structure 30.

The snow chain structure 30 may include a hook-shaped anti-slip member 40 provided on the wheel disk 20 and capable of protruding to the outside of the wheel rim 10 by rotation. The snow chain structure 30 may include a driving unit 50 for driving the anti-slip member 40.

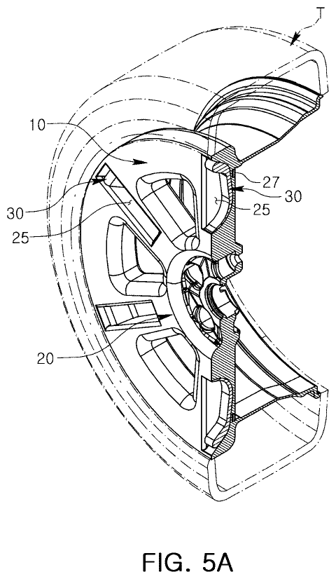

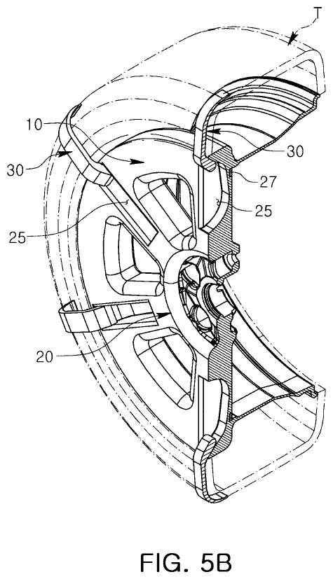

Referring further to FIGS. 5A and 5B, the wheel disk 20 may be provided with a seating groove 25 into which the anti-slip member 40 may be inserted. The seating groove 25 may be provided in the spoke 23 to extend in a radial direction, and may be provided across the spoke 23 and the wheel rim 10.

The seating grooves 25 may be provided to correspond to the number of anti-slip members 40 installed. For example, a seating groove 25 may be provided in each spoke 23. However, the present disclosure is not limited thereto, and may be provided only in some spokes 23.

The seating groove 25 may provide a space into which the anti-slip member 40 can be inserted before/until the anti-slip member 40 rotates about an axis/hinge to unfolded (e.g., in the case of an emergency/icy or slippery driving conditions). A bottom surface of the seating groove 25 may be provided to be rounded into a hook shape to correspond to the shape of the anti-slip member 40.

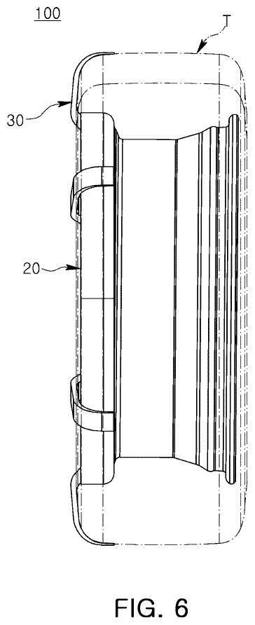

The anti-slip member 40 may be installed to rotate about the axis/hinge (e.g., in the case of an emergency) so as to sufficiently surround a ground surface of the tire T as needed (see FIG. 6, for example). Accordingly, the anti-slip member 40 may be provided in the shape of a hook, and the seating groove 25 may be provided with a sufficiently depth (in the thickness direction, for example) to accommodate the anti-slip member 40 without the anti-slip member protruding to the outside (e.g., in normal times/when the anti-slip member is not needed). The seating groove 25 may be provided in the wheel disk 20 as a groove of as deep a depth as possible/necessary to retract the anti-slip member 40.

Referring further to FIG. 4, the anti-slip member 40 may be provided to rotate about the hinge shaft 45, which may be rotatably fixed to the wheel disk 20. The anti-slip member 40 may be installed to rotate about an axis of the hinge shaft 45 and rotate in a radial direction so that the other end surrounds the tire T. Accordingly, the hinge shaft 45 may extend in a circumferential direction (e.g., a direction perpendicular to the radial direction and perpendicular to the rotation direction of the anti-slip member 40).

Hinge grooves 25a and 25b into which the hinge shaft 45 is inserted and fixed may be provided at an outer end of the groove 25 in the radial direction (e.g., in a radially outward portion of the groove 25 and/or of the wheel disk 20). The hinge shaft 45 may include a first hinge shaft 43 into which the first torsion spring 51 is inserted and a second hinge shaft 44 into which the second torsion spring 53 is inserted.

One ends of the first torsion spring 51 and the second torsion spring 53 may be fixed to the hinge shafts 45-43, 44, and the other ends, opposite to the one ends thereof may be fixed to the wheel disk 20.

For example, the first hinge shaft 43 and the second hinge shaft 44 may be provided with a first fixing groove 43a and a second fixing groove 44a, respectively, and one ends of the first torsion spring 51 and the second torsion spring 53 may be respectively inserted into the first fixing groove 43a and the second fixing groove 44a and fixed, but are not limited to this structure, and can be fixed by various fixing methods.

In the present disclosure, a controller controlling the snow chain structure 30 provided on the vehicle wheel 100 of the present example may be included. The first torsion spring 51 may be electrically connected to the controller, and the controller may control the first torsion spring 51 to apply power (e.g., electricity) or decrease (e.g., stop applying and/or release) the applied power (e.g., electricity).

That is, the vehicle wheel 100 of this example may include a controller configured to apply power to the first torsion spring 51. Power applied to the first torsion spring 51 under control of the controller may cause a temperature of the first torsion spring 51 to increase above a critical temperature, which may cause the anti-slip member 40 to protrude to the outside of the wheel rim 10. Also, or alternatively, if the power applied to the first torsion spring 51 is released (and/or decreased) under the control of the controller and the temperature of the first torsion spring 51 falls below the critical temperature, the anti-slip member 40 may be restored to the inside of the wheel rim 10.

In an example, power (e.g., electricity) applied to the first torsion spring 51 formed of a shape memory alloy) may cause the temperature of the first torsion spring 51 to increases above the critical temperature, such that a restoring force (e.g., torsional torque) is generated in a direction in which the first torsion spring 51 is restored to a shape memorized during a heat treatment process. As a result, the hinge shaft 45, to which one end of the first torsion spring 51 is fixed, may rotate relative to the wheel disk 20, to which the other end thereof is fixed, and the anti-slip member 40 may be installed to rotate about an axis to surround at least a portion of the tire T. In this case, the torsional torque (e.g., restoring force) of the first torsion spring 51 may be stronger than a torsional torque (e.g., elastic force) of the second torsion spring 53.

If the power (e.g., electricity) applied to the first torsion spring 51 formed of a shape memory alloy is released and the temperature of the first torsion spring 51 falls below the critical temperature, restoring force (e.g., torsional torque) may be generated in a direction by which the first torsion spring 51 is restored to its initial shape, thereby applying rotational force to restore the anti-slip member 40 to the original (e.g., retracted) position thereof.

If the power (e.g., electricity) applied to the first torsion spring 51 formed of a shape memory alloy is released and the temperature of the first torsion spring 51 falls below the critical temperature, the elastic force of the second torsion spring 53 may be greater than spring force of the first torsion spring 51, and the anti-slip member 40 may be restored to the original (e.g., retracted) position thereof. The second torsion spring 53 may serve to press the anti-slip member 40 to be positioned in the seating groove 25.

The wheel disk 20 may be provided with a slip ring 27 to apply power (e.g., electricity) to the driving units 50 and 60 (e.g., drivers and/or motors).

The wheel disk 20 may be configured to be connected to an axle of a vehicle and rotates. An apparatus for applying power to the driving unit 50 may be provided in the wheel disk 20. The wheel disk 20 may be provided with a slip ring 27, and the controller may be provided to be fixed to a side of the vehicle connected to the axle. The controller fixed to the side of the vehicle and the wheel disk 20 which is connected to the axle and rotates may be connected to a wiring via a slip ring. Thereby, the controller may safely supply power to the driving unit 50 without disconnecting the wiring, even if the wheel disk 20 is rotating.

Here, the driving units 50 and 60 may include a first torsion spring 51 formed of a shape memory alloy material in an example and a rotation motor 61 in another example.

The vehicle wheel 100 according to an example of the present disclosure may cause snow chains provided on vehicle wheels to be installed to rotate about an axis, by simply operating a driving unit in the case of an emergency, and cause the installation of snow chains to be easily released once a snowy or icy region is passed.

Accordingly, in the present disclosure, a user interface (not shown) provided in the vehicle may be operated to command the supply of power (e.g., electricity) to the driving units 50 and 60 or command the interruption of the supply of power (e.g., electricity).

By the structure disclosed herein, the inconvenience of installing snow chains in the winter or changing tires for the winter, may be eliminated/reduced, and the installation and release thereof may be simply performed by the operation through the user interface, so that the driver's convenience in using snow chains may be increased.

One end of the anti-slip member 40 may be provided on the wheel disk 20 to be rotatable about a rotational axis, and the other end opposite the one end thereof may protrude to the outside of the wheel rim 10 by rotation. The other end protruding to the outside of the wheel rim 10 may surround at least a portion of a side surface of the tire T fitted along an outer diameter of the wheel disk 20.

In detail, the tire T can surround a portion of a tire surface configured to contact the ground, and accordingly, when snow is accumulated or the roads are icy (e.g., in the winter) or otherwise slippery, the anti-slip member 40 contacts the ground and provides additional frictional, thereby improving propulsive force and control.

The anti-slip member 40 may be provided in the shape of a hook, and the anti-slip member 40 may be installed to rotate about an axis in the case of an emergency and sufficiently surround the ground surface of the tire T as needed.

The anti-slip member 40 may be thicker toward one end (e.g., where the hinge shaft 45 is provided) to improve rigidity, and/or conversely, may be thinner toward the other end to improve elasticity. The end of the anti-slip member 40 may have elastic force and/or may be bent. When inserted into the seating groove 25, the anti-slip member 40 can be slightly bent and curved, and when the anti-slip member 40 leaves and/or is out of the seating groove 25, the bent portion can be straightened.

In other words, the anti-slip member 40 includes a hinge shaft 45 rotatably connected to the wheel disk 20, and the thickness of one end of the anti-slip member 40 provided with the hinge shaft 45 may be formed to be thicker than the thickness of the other end thereof. The anti-slip member 40 may include a section of which the thickness gradually becomes thinner from one end to the other end thereof.

The anti-slip member 40 may have a hinge shaft 45 at one end, and the hinge shaft 45 may be provided to rotate while being rotatably fixed to the wheel disk 20. Hinge grooves 25a and 25b into which the hinge shaft 45 is inserted and fixed may be provided at an outer end of the seating groove 25 in a radial direction (e.g., in a radially outward portion of the seating groove 25 and/or wheel disk 20). The hinge shaft 45 may include a first hinge shaft 43 into which the first torsion spring 51 is inserted and a second hinge shaft 44 into which the second torsion spring 53 is inserted.

The anti-slip member 40 may be formed of plastic, steel, and/or steel coated with plastic. For example, the anti-slip member 40 may be formed of urethane-based plastic or a thin and flexible steel material. Alternatively, if necessary, the anti-slip member 40 may be manufactured by injection molding urethane-based plastic on the outside of the steel.

The driving unit 50 may drive the anti-slip member 40 to rotate about an axis of the hinge shaft 45 or be restored (e.g., into the seating groove 25. The driving unit 50 may include a first torsion spring 51 formed of a shape memory alloy, which may be inserted into the hinge shaft 45 and may provide rotational force causing the anti-slip member 40 to protrude.

Also, or alternatively, the hinge shaft 45 may include first and second hinge shafts 43 and 44 provided on both sides of the anti-slip member, and the driving unit 50 may include a first torsion spring 51 (formed of a shape memory alloy) provided on the first hinge shaft 43 and providing rotational force causing the anti-slip member 40 to protrude and a second torsion spring 53 provided on the second hinge shaft 44 and providing restoring force to the anti-slip member 40.

One ends of the first torsion spring 51 and the second torsion spring 53 may be fixed to the hinge shafts 45-43, 44, and the other ends, opposite to the one ends thereof may be fixed to the wheel disk 20.

For example, the first hinge shaft 43 and the second hinge shaft 44 may be provided with a first fixing groove 43a and a second fixing groove 44a, respectively, and one end of the first torsion spring 51 and one end of the second torsion spring 53 may be respectively inserted/fixed into the first fixing groove 43a and the second fixing groove 44a.

Power (e.g., electricity) is applied to the first torsion spring 51 formed of a shape memory alloy may cause a length thereof to be changed. The hinge shaft 45, to which one end of the first torsion spring 51 may be fixed, may rotate relative to the wheel disk 20, to which the other end thereof is fixed.

For example, if power is applied to the first torsion spring 51 formed of a shape memory alloy and heated above a critical temperature, a torsional torque (restoring force) may be generated in the first torsion spring 51, so that rotational force may be applied to the anti-slip member 40, and the anti-slip member 40 may rotate about an axis of the hinge shaft 45 so as to surround at least a portion of the tire T. In this case, the restoring force of the first torsion spring 51 may be stronger than a torsional torque (elastic force) of the second torsion spring 53.

If the power (e.g., electricity) applied to the first torsion spring 51 formed of a shape memory alloy is released, the torsional torque (restoring force) applied to the first torsion spring 51 may be released, and accordingly, as the torsion torque (elastic force) of the second torsion spring 53 becomes greater than that of the first torsion spring 51, rotational force may be applied to restore the anti-slip member 40 to the original position thereof.

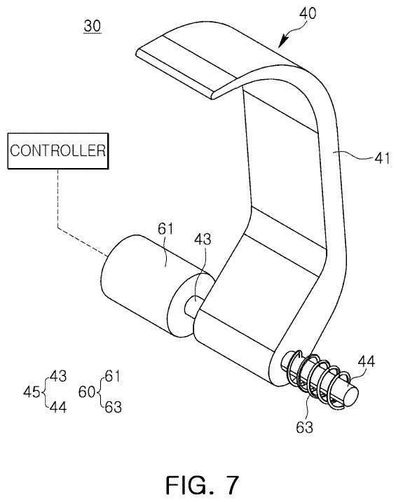

Referring further to FIG. 7, a driving unit 60 according to another example of the present disclosure is disclosed. The structure of the anti-slip member 40, excluding the driving unit 60, may be the same as the structure described above with reference to FIGS. 1 to 6.

The driving unit 60 of another example may be provided with a rotation motor 61 substituting the first torsion spring 43 formed of a shape memory alloy provided in the driving unit 50 of an example. If the power (e.g., electricity) applied to the rotation motor 61 is removed/stopped, the driving unit 60 may include a torsion spring 63 restoring the anti-slip member 40, or pressing the anti-slip member 40 to be located in the seating groove 25.

The driving unit 60 in another example may drive the anti-slip member 40 to rotate about an axis of the hinge shaft 45 and/or be restored. The driving unit 60 may include a rotation motor 61 connected to the hinge shaft 45 and providing rotational force to cause the anti-slip member 40 to protrude.

In the present disclosure, a controller controlling the snow chain structure 30 provided on the vehicle wheel 100 of the present example may be included. The rotation motor 61 may be electrically connected to the controller, and the controller can control the rotation of the rotation motor 61.

Also, or alternatively, the hinge shaft 45 may include first and second hinge shafts 43 and 44 provided on both/either sides of the anti-slip member 40, and the driving unit 60 may include rotation motor 61 connected to the first hinge shaft 43 and providing rotational force to cause the anti-slip member 40 to protrude, and a torsion spring 63 provided on the second hinge shaft 44 and providing restoring force to the anti-slip member 40.

The rotation motor 61 may drive both the rotation and restoration of the anti-slip member 40, and the torsion spring 63 may serve to press the anti-slip member 40 to be located in the seating groove 25.

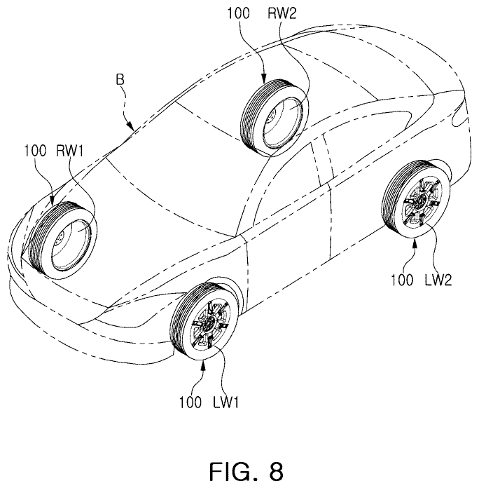

FIG. 8 is a reference diagram illustrating a vehicle on which a vehicle wheel 100 according to an example of the present disclosure is installed.

The vehicle 1 may include a body B, left wheels LWs (LW1, LW2), and right wheels RWs (RW1, RW2) provided on the body B. Also, or alternatively, the vehicle 1 of the present example may include a wheel 100 having a snow chain structure 30 as descried herein, that can cause snow chains (anti-slip members 40) to rotate about an axis (e.g., hinge shaft 45) in the case of an emergency while driving.

The wheel disk 20 may be provided with a slip ring 27 to apply power (e.g., electricity) to driving units 50 and/or 60. The wheel disk 20 may be connected to an axle of a vehicle and rotate, and the slip ring 27 may be a device for applying power to the driving unit 50 provided in the wheel disk 20. The wheel disk 20 may be provided with a slip ring 27 and the axle may be provided with a brush (not shown) for power supply. Here, the driving units 50 and 60 may include a first torsion spring 51 formed of a shape memory alloy material in an example and a rotation motor 61 in another example.

The vehicle wheel 100 according to an example of the present disclosure may cause snow chains provided on vehicle wheels to be installed to rotate about an axis, by simply operating a driving unit in the case of an emergency, and cause the installation of snow chains to be easily released once a snowy or icy region is passed.

Accordingly, in the present disclosure, a user interface (not shown) provided in the vehicle may be operated to command the supply of power (e.g., electricity) to the driving units 50 and 60 or command the interruption of the supply of power (e.g., electricity).

In order to solve at least a portion of the above-described problems, an aspect of the present disclosure is to provide a snow chain structure having a simple structure, and that can be easily and efficiently installed in the case of an emergency such as during snowfall or when roads are icy.

Also, or alternatively, an aspect of the present disclosure is to provide a structure which causes snow chains provided on vehicle wheels to be installed to rotate about an axis, by simply operating a driving unit in the case of an emergency, and causes the installation of snow chains to be easily released once a snowy or icy region is passed.

The purpose of the present disclosure is not limited to the purposes mentioned above, and other purposes not mentioned will be clearly understood by those skilled in the art from the description below.

According to an aspect of the present disclosure, a vehicle wheel may include: a wheel disk including a hub, a plurality of spokes extending from the hub in a radial direction, and a wheel rim provided outside of the spokes; a hook-shaped anti-slip member provided on the wheel disk and capable of protruding to the outside of the wheel rim by rotation; and a driving unit driving the anti-slip member.

Here, the anti-slip member may have one end provided on the wheel disk to be rotatable about a rotational axis and the other end opposite to the one end thereof protruding to the outside of the wheel rim by rotation.

Also, or alternatively, the wheel disk may be provided with a seating groove into which the anti-slip member is inserted.

Also, or alternatively, the seating groove may have a rounded bottom surface in a hook shape corresponding to the shape of the anti-slip member.

Also, or alternatively, the seating groove may be provided to extend in a radial direction in the spoke.

Also, or alternatively, the anti-slip member may be provided with a hinge shaft rotatably inserted into the wheel disk at an outer end thereof in a radial direction.

Also, or alternatively, the driving unit may include a first torsion spring formed of a shape memory alloy which is inserted into the hinge shaft and provides rotational force, causing the anti-slip member to protrude.

Also, or alternatively, the hinge shaft may include first and second hinge shafts provided on both sides of the anti-slip member, and the driving unit may include a first torsion spring provided on the first hinge shaft and a second torsion spring provided on the second hinge shaft and providing restoring force to the anti-slip member.

Also, or alternatively, one ends of the first torsion spring and the second torsion spring may be fixed to the hinge shaft, and the other ends, opposite to the one ends thereof may be fixed to the wheel disk.

Also, or alternatively, the driving unit may include a rotation motor which is inserted into the hinge shaft and provides rotational force, causing the anti-slip member to protrude.

Also, or alternatively, the hinge shaft may include first and second hinge shafts provided on both sides of the anti-slip member, and the driving unit may include a rotation motor provided on the first hinge shaft and a torsion spring provided on the second hinge shaft and providing restoring force to the anti-slip member.

Also, or alternatively, a tire provided on the outside of the wheel disc may be further included, and the anti-slip member may protrude to the outside of the wheel rim by rotation and surround the tire.

Also, or alternatively, the anti-slip member may be formed of plastic, steel, or steel coated with plastic.

Also, or alternatively, a controller applying power to the first torsion spring may be included, and when power is applied to the first torsion spring under control of the controller, and a temperature of the first torsion spring increases above a critical temperature, the anti-slip member may protrude to the outside of the wheel rim.

Also, or alternatively, when the power applied to the first torsion spring is released under the control of the controller and the temperature of the first torsion spring falls below the critical temperature, the anti-slip member may be restored to the inside of the wheel rim.

Also, or alternatively, the anti-slip member may include a hinge shaft rotatably connected to the wheel disk, and the anti-slip member may include a section in which a thickness of one end of the anti-slip member, provided with the hinge shaft is formed to be thicker than a thickness of the other end thereof, and the thickness gradually becomes thinner in a direction from one end thereof to the other end thereof.

According to an aspect of the present disclosure, a vehicle may include: a body; and the vehicle wheel of an example of the present disclosure provided to enable the body to travel.

Here, the driving unit may be a torsion spring formed of a shape memory alloy or a rotation motor.

By the structure disclosed herein, the difficulty of installing snow chains in the winter and/or changing tires for the winter, may be eliminated and/or reduced, and the installation and/or release of tires and/or snow chains may be performed simply by the operation via the user interface. As such, driver convenience in using snow chains may be increased.

As set forth above, according to an example of the present disclosure, a vehicle wheel has a simple structure, so snow chains may be easily and efficiently installed in the case of an emergency, such as during snowfall or when roads are icy.

Also, or alternatively, in the present disclosure, the snow chains provided on the vehicle wheel may be installed by simply operating a driving unit to be installed to rotate about an axis, and the installation of snow chains may be easily released again. once a snowy or icy region is passed.

Also, or alternatively, in the present disclosure, the installation and release of snow chains may be performed simply by button operation, thereby improving the driver's convenience in using the snow chains.

The effects of the present disclosure are not limited to those described above, and other effects not mentioned will be clearly recognized by those skilled in the art from the description below.

While the example examples have been illustrated and described above, it will be apparent to those skilled in the art that modifications and variations could be made without departing from the scope of the present invention as defined by the appended claims.

What is claimed is:

1. A vehicle wheel, comprising:
a wheel disk comprising:
a hub;
a plurality of spokes extending from the hub in an outward radial direction; and
a wheel rim provided radially outside of the spokes;
a hook-shaped anti-slip member connected to the wheel disk so as to be capable of reversibly rotating about an axis on the wheel rim so as to protrude radially outside of the wheel rim; and
a driver configured to drive the anti-slip member to rotate about the axis.

2. The vehicle wheel of claim 1, wherein the anti-slip member comprises:
a first end connected to the wheel disk via a connection forming the axis, and
a second end, opposite to the first end, configured to protrude radially outside of the wheel rim by rotation of the anti-slip member at the first end.

3. The vehicle wheel of claim 1, wherein a seating groove, formed in the wheel disk, is configured to accommodate the anti-slip member.

4. The vehicle wheel of claim 3, wherein the seating groove comprises a rounded surface in a hook-shape corresponding to the hook-shape of the anti-slip member.

5. The vehicle wheel of claim 3, wherein the seating groove extends in a radial direction in a spoke of the plurality of spokes.

6. The vehicle wheel of claim 1, wherein the axis comprises a hinge shaft, of the anti-slip member, rotatably inserted into a radially outward portion of the wheel disk.

7. The vehicle wheel of claim 6, wherein the driver comprises a first torsion spring, formed of a shape memory alloy, inserted into the hinge shaft and configured to provides a rotational force to cause the anti-slip member to rotate to protrude radially outside of the wheel rim.

8. The vehicle wheel of claim 7, wherein the hinge shaft comprises a first hinge shaft and a second hinge shaft provided on either side of the anti-slip member in a circumferential direction of the vehicle wheel, and
wherein the driver:
comprises a first torsion spring provided on the first hinge shaft and a second torsion spring provided on the second hinge shaft, and
is configured to provide a restoring force to the anti-slip member.

9. The vehicle wheel of claim 8, wherein a first end of the first torsion spring and a first end of the second torsion spring are each fixed to the hinge shaft and a second end of the first torsion spring and a second end of the second torsion spring are fixed to the wheel disk.

10. The vehicle wheel of claim 6, wherein the driver comprises a rotation motor, which is inserted into the hinge shaft and configured to provide rotational force to cause the anti-slip member to rotate to protrude radially outside of the wheel rim.

11. The vehicle wheel of claim 10, wherein the hinge shaft comprises a first hinge shaft and a second hinge shaft provided on either side of the anti-slip member in a circumferential direction of the vehicle wheel, and
wherein the driver comprises a torsion spring provided on the second hinge shaft and configured to provide restoring force to the anti-slip member.

12. The vehicle wheel of claim 1, further comprising:
a tire provided radially outside of the wheel disk,
wherein the anti-slip member is configured to rotate to protrude radially outside of the wheel rim and to surround the tire.

13. The vehicle wheel of claim 1, wherein the anti-slip member is formed one or more of plastic, steel, or steel coated with plastic.

14. The vehicle wheel of claim 7, further comprising a controller configured to apply power to the first torsion spring such that a temperature of the first torsion spring increases above a critical temperature, causing the anti-slip member to rotate to protrude outside of the wheel rim.

15. The vehicle wheel of claim 14, wherein, the controller is configured to decrease the power applied to the first torsion spring such that the temperature of the first torsion spring falls below the critical temperature, causing the anti-slip member to be restored to inside of the wheel rim.

16. The vehicle wheel of claim 1, wherein the anti-slip member comprises a hinge shaft rotatably connected to the wheel disk, and
wherein a thickness of a first end, of the anti-slip member, connected to the hinge shaft is thicker than a second end of the anti-slip member.

17. A vehicle, comprising:
a body; and
the vehicle wheel of claim 1.

18. The vehicle of claim 17, wherein the driver comprises one or more of:
a torsion spring formed of a shape memory alloy; or
a rotation motor.
